(19) United States
(12) Patent Application Publication
(10) Pub. No.: US 2013/0310095 A1
(43) Pub. Date: Nov. 21, 2013

(54) Method of Determining an Optimal Configuration for Rehoming Base Stations

(71) Applicant: Jad El-Najjar, Montreal (CA)

(72) Inventor: Jad El-Najjar, Montreal (CA)

(73) Assignee: TELEFONAKTIEBOLAGET L M ERICSSON (PUBL), Stockholm (SE)

(21) Appl. No.: 13/474,823

(22) Filed: May 18, 2012

(51) Int. Cl. H04W 36/22; H04W 36/30; H04W 36/10

(52) U.S. Cl. 455/507

(57) ABSTRACT

A method of iteratively determining an optimal configuration for rehoming a plurality of base stations among a plurality of RNCs is disclosed. In a first iteration, a proposed rehoming configuration and an associated performance metric indicative are determined. The performance metric is indicative of a load imbalance of the proposed rehoming configuration, a quantity of inter-RNC handovers that would be exhibited by the proposed rehoming configuration, or both. A plurality of additional rehoming configurations are iteratively determined by: selecting one of a simulated annealing algorithm, an intensification algorithm, or a diversification algorithm responsive to a type of algorithm used in the preceding iteration, the performance metric of one or more preceding iterations, or both; and performing the selected algorithm to identify an additional rehoming configuration. Responsive to a completion event, a determined rehoming solution having a performance metric exhibiting a greatest improvement is outputted.

### TECHNICAL FIELD

The present invention relates to wireless network optimization, and more particularly relates to rehoming a plurality of base stations among a plurality of base station controllers.

### BACKGROUND

Code Division Multiple Access (CDMA) networks, such as Wideband CDMA (WCDMA) networks, utilize radio base stations (also known as “NodeBs”) to support wireless communication with wireless terminals. Wireless terminals can include mobile phones, laptop computers, tablets, etc. that are equipped to communicate wirelessly with a NodeB. In such networks, each terminal is also known as a user equipment or “UE.”

Each NodeB is supported by a radio network controller (RNC). RNCs communicate with each other via an “IUR” interface, and communicate with their NodeBs via an “Iub” interface. An RNC often supports multiple NodeBs. Each RNC has a main processor (MP) which exhibits an MP load indicative of the load of its associated NodeBs. It is desirable to spread the MP load proportionally among all RNCs, so that certain RNCs are not overburdened while other RNCs have excess unused capacity.

In order to deal with load imbalance among RNCs, NodeBs may be redistributed amongst the RNCs, which is known as “rehoming.” To rehome a NodeB, the Iub-link that connects the NodeB to its RNC is redefined logically and physically, and other modifications may also need to be done, such as updating neighboring cell relations definition and cell creation.

Identifying an optimal rehoming configuration that provides the smallest possible load imbalance is computationally demanding and time-consuming, because the number of potential rehomes in a WCDMA RAN network is exponential as compared to the size of that network. Assume, for example, that a WCDMA radio access network (RAN) included 10 RNCs and 1,000 NodeBs. In this example, there would theoretically be 10¹⁰⁰⁰ possible rehoming configurations. Assuming that a machine could process up to 1,000 rehomes a second (i.e., 3.1536*10¹⁰ rehomes per year), it would still take approximately 3*10⁹⁸⁹ years to explore all possible rehomes in order to identify the optimal solution. The generalized formula of possible theoretical NodeBs rehomes in a WCDMA network, assuming that is composed of n RNCs and m NodeBs is n^{m}. Prior art rehoming has therefore been performed on the fly on an ad-hoc basis, leading to inefficient rehoming, and short term solutions at best.

### SUMMARY

An exemplary method of iteratively determining an optimal configuration for rehoming a plurality of base stations among a plurality of radio network controllers (RNCs) within a wireless communication network is provided. According to the method, in a first iteration a proposed rehoming configuration and an associated performance metric are determined. The performance metric is indicative of a load imbalance of the proposed rehoming configuration, a quantity of inter-RNC handovers that would be exhibited by the proposed rehoming configuration, or both. A plurality of additional rehoming configurations are iteratively determined by: selecting one of a simulated annealing (SA) algorithm, an intensification algorithm, or a diversification algorithm responsive to a type of algorithm used in the preceding iteration, the performance metric of one or more preceding iterations, or both; and performing the selected algorithm to identify an additional rehoming configuration. Responsive to a completion event, a determined rehoming solution having a performance metric exhibiting a greatest improvement as compared to a performance metric of an initial allocation of the plurality of base stations among the plurality of RNCs is outputted.

An exemplary network node operative to iteratively determine an optimal configuration for rehoming a plurality of base stations among a plurality of radio network controllers (RNCs) within a wireless communication network is also disclosed. The network node includes one or more processing circuits configured to: determine, in a first iteration, a proposed rehoming configuration and an associated performance metric indicative of a load imbalance of the proposed rehoming configuration, a quantity of inter-RNC handovers that would be exhibited by the proposed rehoming configuration, or both. The one or more processing circuits are further configured to iteratively perform the following to determine a plurality of additional rehoming configurations: select one of a simulated annealing (SA) algorithm, an intensification algorithm, or a diversification algorithm responsive to a type of algorithm used in the preceding iteration, the performance metric of one or more preceding iterations, or both; and perform the selected algorithm to identify an additional rehoming configuration. Responsive to a completion event, a determined rehoming solution having a performance metric exhibiting a greatest improvement as compared to a performance metric of an initial allocation of the plurality of base stations among the plurality of RNCs is outputted by the one or more processing circuits.

Exemplary completion events may include: performance of a predefined quantity of iterations; a predefined quantity of iterations being performed without identifying any rehoming configurations whose performance metric offers an improvement over a current optimal configuration; or a rehoming configuration determination time period transpiring.

In one example, the performance metric is determined by comparing an actual total load of each the plurality of base stations to a total capacity of all of the RNCs to determine an optimum load for each RNC; determining, for each RNC, a magnitude of the difference between the optimum load for the RNC and a current load for the RNC; and defining a sum of the magnitudes to be the load imbalance.

In the same or another example, each performance metric is a weighted sum of the load imbalance for a proposed rehoming configuration and the estimated number of IUR interface handovers that would be exhibited by a corresponding proposed rehoming configuration.

In one example, performance of the SA algorithm to identify an additional rehoming configuration includes randomly relocating a base station to a different RNC.

In one example, performing the intensification algorithm to identify an additional rehoming configuration includes moving one of the base stations to a selected RNC, wherein an actual load of the selected RNC is lower than its optimal load, and wherein the move will decrease the load imbalance of the selected RNC.

In one example, performance of the diversification algorithm to identify an additional rehoming configuration includes moving one of the base stations to a selected RNC if the move will provide a load balance imbalance reduction, even if the move will increase a load imbalance of the selected RNC.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of an example WCDMA wireless communication network.

FIG. 2 is a block diagram illustrating an exemplary initial allocation of a plurality of base stations among a plurality of Radio Network Controllers (RNCs).

FIG. 3 illustrates an exemplary method of determining rehoming configurations using a simulated annealing algorithm.

FIG. 4 illustrates a detailed exemplary method of determining rehoming configurations using a hybrid meta-heuristic approach.

FIG. 5 illustrates an example method for selecting an algorithm for use in a given iteration of the method of FIG. 4.

FIG. 6 illustrates a high level exemplary method of determining rehoming configurations using a hybrid meta-heuristic approach.

FIG. 7 illustrates an example network node operable to implement at least one of the method of FIG. 4 and the method of FIG. 6.

FIGS. 8-15 illustrate a plurality of rehoming configurations, each corresponding to an iteration of the method of FIG. 4.

### DETAILED DESCRIPTION

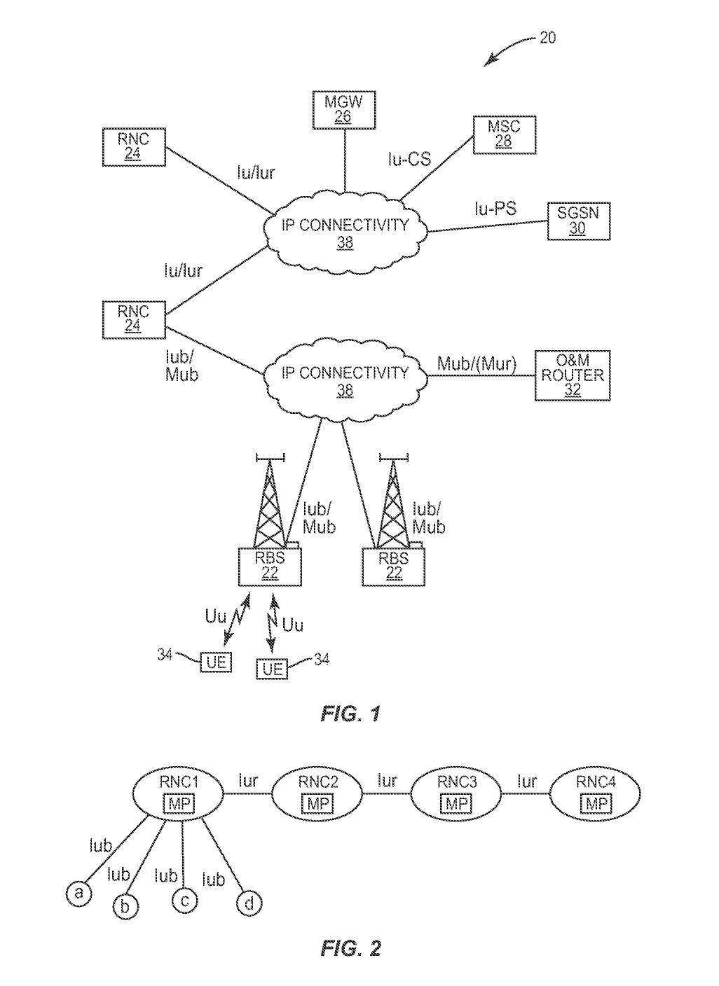

FIG. 1 is a block diagram of an exemplary WCDMA wireless communication network 20 including a plurality of Radio Base Stations (RBSs) 22, and a plurality of Radio Network Controllers (RNCs) 24. The base stations 22 support wireless communications with wireless terminals 34. As discussed above, in WCDMA networks, a base station 22 is also referred to as a NodeB, and wireless terminals are also referred to as user equipment (UE). Each base station 22 communicates with its assigned RNC 24 via a “Iub” interface, and communicates with the UEs via a “Uu” air interface. The base stations 22 and RNCs collectively form a Radio Access Network (RAN) portion of the overall network 20. The RNCs 24 control the NodeBs and the radio resources, and act as a service access point providing services to a core network (not shown). Each NodeB provides physical resources and converts the data flow between the Iub and Uu interfaces.

The Iub interface may correspond to wireless or wired IP connectivity 38, via a wide area network (WAN), for example). Notably, the “Iur” interface provides connectivity between two RNCs. The Iur interface uses Radio Network Subsystem Application Part (RNSAP) signaling protocol when a UE moves from one RNC to another RNC coverage area without call interruption (which we refer to as an “Iur handover”). Hence handover traffic between RNCs is routed via the Iur interface. A handover between two NodeBs assigned to a single RNC, though, is not an Iur handover.

Additional components 26, 28, 30 and 32 may also be included in a WCDMA network. Media Gateway (MGW) 26 converts digital media streams between different telecommunication networks. Mobile Switching Center (MSC) 28 processes requests for service connections from mobile devices and land line callers, and routes calls between the base stations and the public switched telephone network (PSTN). Serving GPRS Support Node (SGSN) 30 (with “GPRS” referring to “General Packet Radio Service”) assists with packet routing and transfer for mobile terminals connected to legacy radio area networks. Operations & Maintenance (O&M) router 34 acts as an interface between the network 20 and one or more Operations & Maintenance nodes. Although additional interfaces are shown in FIG. 1 (e.g., Iu-CS, Iu-PS, Mub), operation of these interfaces is understood by those of ordinary skill in the art, and these interfaces will therefore not be discussed in detail.

FIG. 2 is a block diagram illustrating an exemplary initial allocation of a plurality of base stations (a, b, c and d) among a plurality of Radio Network Controllers (RNCs) (RNC1, RNC2, RNC3 and RNC4). As shown in FIG. 2, each RNC has a main processor (MP), which may become overloaded if it is forced to handle too much NodeB traffic. This can result in a so-called “MP load imbalance” among the RNCs, meaning some RNCs are over-utilized and some RNCs are under-utilized. To address this, NodeB rehoming may be performed. Thus, the MP load may be used as a performance metric to determine when rehoming is appropriate, and to determine how good a given rehoming configuration is.

MP load is impacted by several factors such as RRC (Radio Resource Control) signaling, as increased traffic flowing along the RNC leads to increased RRC signaling and correspondingly increased MP load. Another factor that can impact the RNC performance is an amount of Iur handovers, as Iur handovers lead to increased signaling among the RNCs, increased connection delay (when compared to a handover involving one RNC), and hence increased buffered data.

Some additional exemplary factors that may affect MP load include one or more of: a number of Radio Access Bearer establishments per second; a number of successful speech call establishments per second; a quantity of successful High Speed Downlink Access (HSDPA) interactive connections per second, a quantity of inter-RAT handovers (with “RAT” referring to “Radio Access Technology”); a quantity of inter-frequency handovers; a quantity of soft handovers (i.e., intra-RNC handovers); a quantity of paging performed; and a quantity of channel up-switches or down-switches.

In order to deal with increased MP load imbalance among RNCs (i.e., RNCs that are experiencing higher MP load with respect to their capacity, while others are experiencing lower MP load with respect to their capacity) and increased Iur handover, NodeB rehomes are performed.

As discussed above, a NodeB rehome refers to moving a NodeB from its parent RNC to another neighboring RNC, which therefore will become its new parent RNC. The Iub-link that connects the NodeB and the RNC is redefined logically and physically to take care of these changes in a rehome. Other modifications are also implemented, such as neighboring cell relations definition and cell creation.

A NodeB may be rehomed when its parent RNC is experiencing MP load imbalance and high Iur handover. Moving a NodeB to another parent RNC can load balance the MP load on the involved RNCs while reducing the Iur handover (i.e., limiting the soft handovers of UEs, when moving between coverage areas belonging to NodeBs, to be part of the same parent RNC).

Historically, when a customer's WCDMA RAN network starts experiencing downgraded services such as increased Iur handover and RNCs overload or underuse of its main processors' MP load, NodeB rehomes are performed on the fly and based on common sense to try to reduce the MP load imbalance on the RNCs along with reduced Iur handover. However such a strategy is not efficient, as relying on common sense and pure instinct can only be helpful for a short term solution, and is inefficient in a network that has an exponential amount of potential NodeBs rehomes. As discussed above, a brute force determination of an optimal rehoming configuration has simply not been possible in the prior art due to the computational demands of such a determination.

A novel method of iteratively determining an optimal configuration for rehoming a plurality of base stations among a plurality of radio network controllers (RNCs) is set forth below. This method uses meta-heuristic approaches to efficiently explore, in a short amount of time, the exponential number of potential NodeBs rehomes, identifying those that will lead to a global optimal solution with minimized MP load imbalance and reduced Iur handover. This meta-heuristic approach facilitates an efficient exploration in a short amount of time, of the set of exponential feasible rehomes, and further facilitates selection of the solutions that would lead to a global optimum solution (i.e., a solution having a best performance metric).

A heuristic method is a procedure that tries to discover the global optimal feasible solution for a specific problem being considered. Heuristic methods are iterative in nature, and after each iteration, a feasible solution of the specific problem is identified. The problem considered is non-polynomial to solve (i.e., an exponential amount of time is required to fetch the optimal solution). When the heuristic method is terminated after an amount of time or iterations, the output solution is the best solution found in any iteration.

A meta-heuristic, however, is a general solution method that provides both a generalized structure and strategy guidelines for developing a specific heuristic method to fit a particular problem. The nature of a meta-heuristic relies on orchestrating the interaction between local improvement procedures and higher level strategies to create a process that is capable of escaping from local optima and performing a robust search of a feasible region in order to converge to the global optimum.

The meta-heuristic approaches used in the method described below are Simulated Annealing (SA) and Tabu search. These meta-heuristic approaches search the feasible domain of solutions in a smart and efficient way, in order to obtain a global optimum solution of the mathematical model objective. Because multiple meta-heuristics are used, the method will be described as a “hybrid meta-heuristic.” An objective of the hybrid meta-heuristic approach is to minimize the MP load imbalance on all RNCs part of the network while also maintaining a reduced Iur handover. This may be referred to as “hierarchical multi-objective,” since it first minimizes the MP load imbalance and as a second priority reduces the Iur handover. Note, however, that the prioritization could be reversed.

A mathematical model associated with NodeB rehoming is shown below:

Minimize C(s)={WL*CMP_load_imbalance(s)+WIUR*Ciur_HOs(s)} eq. (1)

Minimize C(s)={WL*Total_MP_Load_Imbalance(s)+WIUR*Total_{—}IUR_HOs Ciur_{HOs}(s)} eq. (2)

where
C(s) is the objective cost associated with a state s;
WL is a weight corresponding to a load imbalance reduction priority;
WIUR is a weight corresponding to an IUR handover reduction priority;
CMP_load_imbalance refers to MP load imbalance; and
Ciur_HOs refers to IUR interface handovers.

C(s) is the network objective function associated with a network configuration or state s. This objective function can be compared to a cost in order to measure the total MP load imbalance in the network RNCs and the total Iur handovers present. Minimizing such cost will yield increased network performances and hence better customer services.

CMP_load_imbalance(s)=Total_MP_Load Imbalance(s) defines the total MP load imbalance associated with the state s.

Ciur_HOs (s)=Total_Iur_HO(s) defines the total Iur handover associated with the state s.

Also, sεS, where S is the set of all possible states or network configurations resulting from NodeBs rehomes.

WL and WIUR are weights to emphasis on which component of the multi-objective (i.e., MP load imbalance reduction or IUR handover reduction) has the highest priority to be minimized first. As mentioned above, this may be referred to as “hierarchical multi-objective.”

In view of the above, the mathematical model can be rewritten as follows:

Minimize C(s)={WL*(ΣiRNCi_MP_Load_Imbalance)*ys+WIUR*(ΣiIUR_HO_RNCi)*ys} eq. (3)

where:

Σsys=1 (only one state s or network configuration must be chosen at a time);

“ys” is a binary variable that is equal 1 if the state s is chosen, 0 otherwise; and

“i” is an incremental index that has 1 as a lower bound and total number of RNCs in the Market/network as an upper bound; and

RNCi_MP_load imbalance defines the MP load imbalance at RNCi, whereas IurHO_RNCi defines the Iur handovers present at RNCi.

As mentioned earlier, the RNC MP load imbalance refers to RNCs that are experiencing higher MP load with respect to their capacity, while others are experiencing lower MP load with respect to their capacity. The RNC capacity for a given RNC may be calculated based on its type and/or on its number of general-purpose processor boards (GPBs) and their types, etc. Other criteria may be used to calculate the RNC capacity depending on customer requests.

The Iur handovers present on each RNC are computed based upon the soft handovers happening on their children source base stations (e.g., NodeBs). In order to identify which soft handovers are Iur handovers, a check is performed to determine if the soft handovers happening on those children source NodeB have their target NodeB not part of the same RNC. If that is the case, then these soft-handovers will be identified as Iur handover. Also, some other RNC counters such as (pmSoftSofterHOSuccessIur) can be used to calculate the amount of Iur handovers present on each RNC.

One of the meta-heuristics in the hybrid meta-heuristic may be based on Simulated Annealing (SA), such that SA is used as a basic algorithm to minimize the MP load imbalance (first priority) while reducing the Iur handover (second priority) as described previously in the mathematical model.

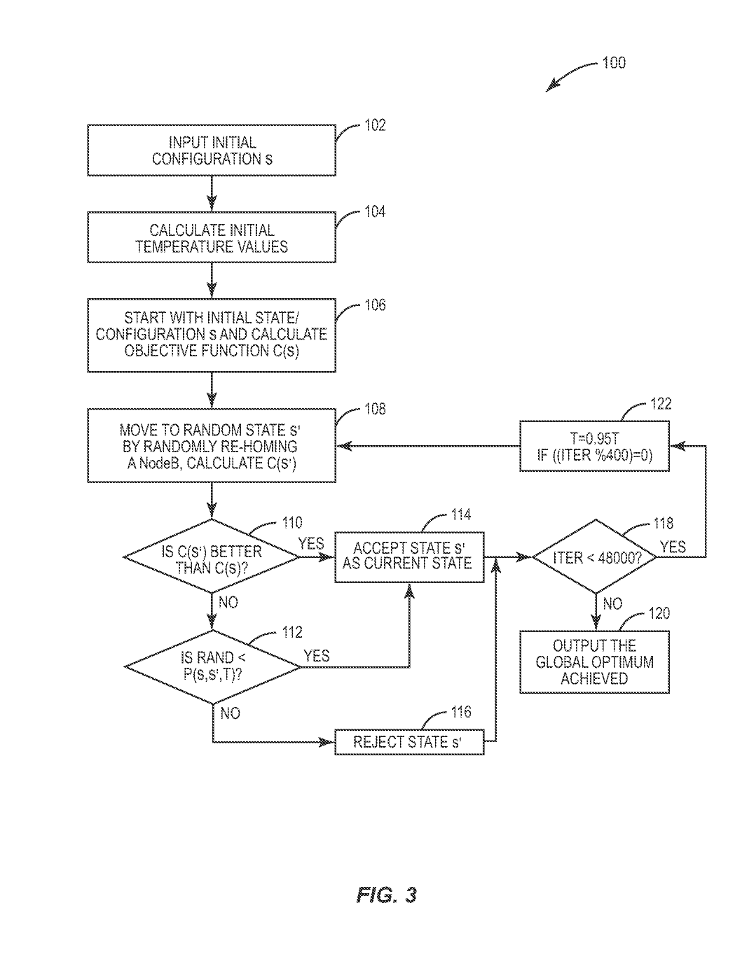

SA is a meta-heuristic designed to escape the local optima. In the example of FIG. 3, it starts by choosing some random directions that might downgrade a current solution, based on an acceptance probability. However, since most of its accepted random directions are upward, the SA will gravitate toward those parts of the feasible domain that contains the best solutions, hence leading to the global optimum solution. The search gradually emphasizes accepting moves upward while rejecting an increasing amount of moves that will downgrade the current solution. This is done based on some temperature parameters that decrease the probability of accepting downgrading solutions as the SA iterations are increasing through time.

FIG. 3 illustrates an exemplary method 100 of determining rehoming configurations based on a SA algorithm. Here, we define an immediate neighboring configuration/solution or state s′ as a configuration obtained from the current configuration s by performing a NodeB (randomly picked) rehome from a source RNC to a neighboring target RNC (randomly chosen).

An initial solution, which may be a current WCDMA RAN network configuration (i.e., an allocation of a plurality of base stations among a plurality of RNCs as shown in FIG. 2) is used as an input in (step 102) order to obtain as output a global optimized solution associated with the rehomes to be performed on this initial or current customer solution/configuration.

Temperature values T_MP_load imbalance and T_Iur_handover are calculated for the initial solution (step 104). These temperature values are used to reduce the probability that a bad solution will be accepted during iterations of the method 100. T_MP_load_imbalance and T_Iur_handover initial values may be calculated based on the network topology and configuration provided as input to the tool. As discussed below, these values may be gradually decreased (e.g., by 5% every 400 iterations) to gradually keep reducing the probability that an inferior solution will be increased.

Once the initial temperature values are calculated (step 104), the objective function C(s) is calculated for an initial allocation of base stations among a plurality of RNCs (step 106). Then, a random state s′ is selected by randomly rehoming a NodeB, and the objective function C(s′) is recalculated for the random state s′ (step 110). Whether or not the new state s′ is accepted as a solution, depends on how C(s) compares to C(s′) (step 108), as described below. The comparison of C(s) to C(s′) is described in cases A-D below. In this discussion, CMP_load_imbalance(s) and Ciur_HO(s′) represent the MP load imbalance and the Iur handovers associated with the new state s′, and P(s,s′,T) represents the probability of accepting or rejecting the state s′ as a possible solution. How this probability function is calculated depends on the outcome of the comparison of step 108.
Case A: CMP_load_imbalance (s)>CMP_load_imbalance(s) and Ciur_HO (s′)<Ciur_HO(s)

In this example, the objective function (or “performance metric”) for the load imbalance (CMP_load_imbalance) has increased (i.e., worsened), but the performance metric for the Iur handovers (Ciur_HO) has decreased (i.e., improved). Here, the probability function P may be calculated as follows:

$$P ( s , {s}^{′} , T ) = {e}^{\frac{- WL * ( CMP \_ load \_ imbalance ( {s}^{′} ) - CMP \_ load \_ imbalance ( s ) )}{T\_MP \_load \_imbalance}} \qquad eq . ( 4 )$$

Case B: CMP_load_imbalance (s′)<CMP_load_imbalance(s) and Ciur_HO (s′)>Ciur_HO(s)

In this example, the performance metric for the load imbalance (CMP_load_imbalance) has decreased (i.e., improved), but the performance metric for the Iur handovers (Ciur_HO) has increased (i.e., worsened). Here, the probability function P may be calculated as follows:

$$P ( s , {s}^{′} , T ) = {e}^{\frac{- WIUR * ( Ciur \_ HO ( {s}^{′} ) - Ciur \_ HO ( s ) )}{T\_Iur \_handover}} \qquad eq . ( 5 )$$

Case C: CMP_load_imbalance (s)>CMP_load_imbalance(s) and Ciur_HO (s′)>Ciur_HO(s)

In this example, the performance metrics for each of the load imbalance and the IUR handover have increased (i.e., worsened). Thus, the random selection of the iteration has found solution that is worse than a previous solution. Here, the probability function P may be calculated as follows:

$$P ( s , {s}^{′} , T ) = {e}^{\frac{- WL * ( CMP \_ load \_ imbalance ( {s}^{′} ) - CMP \_ load \_ imbalance ( s ) )}{T\_MP \_load \_imbalance}} * {e}^{\frac{- WIUR * ( Ciur \_ HO ( {s}^{′} ) - Ciur \_ HO ( s ) )}{T\_Iur \_handover}} \\ \qquad eq . ( 6 )$$

Case D: CMP_load_imbalance (s′)<CMP_load_imbalance (s) and Ciur_HO (s′)<Ciur_HO(s)

In this example, the performance metric for each of the load imbalance and the IUR handover have decreased (i.e., improved). Here, the probability function P may simply be set to 1, guaranteeing that the solution in question will be accepted. In FIG. 3, this corresponds to C(s) being better than C(s) in step 110.

P(s,s′,T)=1 eq. (7)

Referring again to FIG. 3, if the C(s) performance metric for both the MP load imbalance and Iur handovers (or the weighted sum of both of these performance metrics) is not better (i.e., lower) than the previous performance metric value C(s), the probability function P value is compared to a random value RAND, which is a random number between 0 and 1 (step 112). If RAND is less than P(s,s′,T) then the solution is accepted (step 114). Otherwise, if RAND is greater than P(s,s′,T) then the solution in question is rejected (step 116).

A check is then performed to see if a predefined quantity of iterations have been performed (step 118). In the example of FIG. 3, this predefined quantity is defined as 48,000 iterations. However, it is understood that this is only an example, and that other quantities of iterations could be used.

If the predefined quantity of iterations has been reached, then a global optimum achieved rehoming configuration solution is outputted (step 120). Otherwise, additional iterations are performed. The temperature values may also be decreased gradually over time (step 122). In the example of FIG. 3, every 400 iterations, the temperature values are decreased by 5%, which overtime continually reduces the probability that worsened solutions will be accepted. Of course, this is only an example, and other temperature reductions could be performed (e.g., of a different magnitude, and at different intervals).

Thus, as depicted form FIG. 3, the SA-based method 100 is fed with the an initial WCDMA RAN network configuration, and starts performing some random NodeB rehomes, always accepting those that will lead to a better network performance (minimized MP load imbalance and reduced Iur handover), and also accepting, with probability P(s,s′,T), some rehomes that might downgrade the current configuration. This is done in order to escape local optima solutions, and move the search to unexplored regions of the domain of feasible solutions or states. As the SA moves forwards through time (iterations increases), the temperatures parameters decreases (P(s,s′,T) decreases), which will lead to accepting fewer downgrading states.

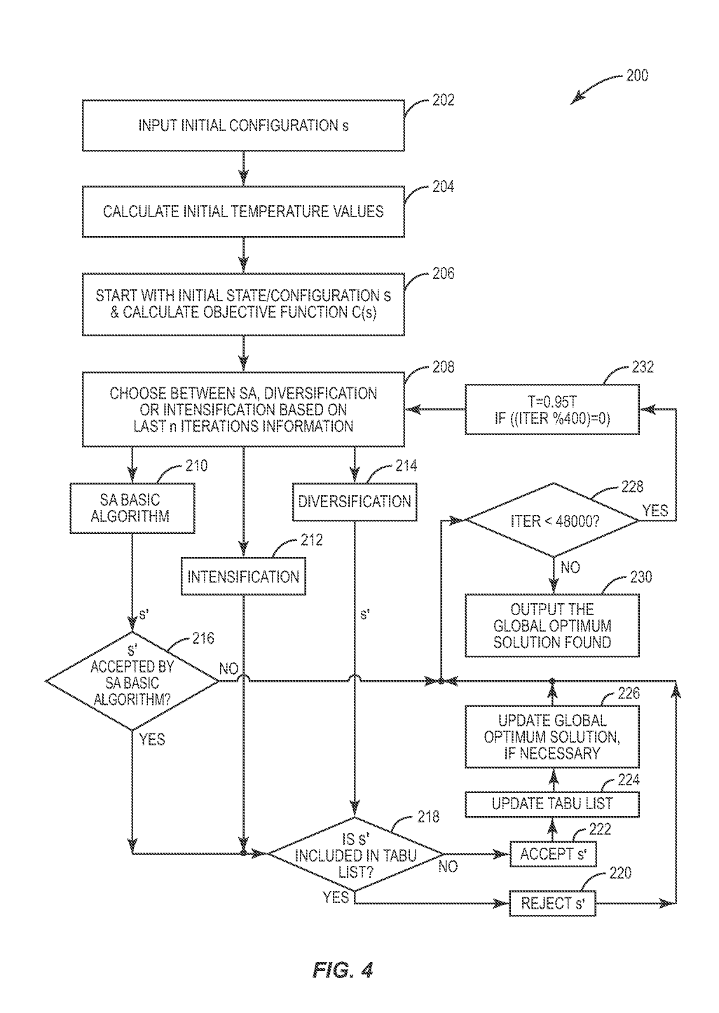

FIG. 4 illustrates a detailed exemplary method 200 of determining rehoming configurations using a hybrid meta-heuristic algorithm that incorporates both of the SA and Tabu Search meta-heuristics.

The Tabu Search starts with a feasible initial solution, such as an initial WCDMA RAN network configuration. Then from a set of potential neighboring rehomes it selects the best neighboring rehome regardless if its performance metric is better or worse than the performance metric of the current solution. Afterwards, it updates a “Tabu list” which is used in order to avoid cycling back to what had been the current solution. If the Tabu list becomes full, the oldest member part of this list may be removed. The stopping criterion of the Tabu Search meta-heuristic could be the number of iterations, the elapsed amount of time or a fixed number of consecutive iterations without any improvement, for example. In one example, only accepted solutions are included in the Tabu list (and rejected solutions are excluded).

In addition to the Tabu list, the Tabu Search meta-heuristic has some particular characteristics that make it a powerful strategy to converge to global optimum solution. The first characteristic is “intensification.” If a viable solution is found, and a source and target RNC have been identified as potential elements for improving the current solution, for several moves/iterations to come, intensification is considered to focus on the upcoming moves where both source and target RNCs are part of. The intensification strategy is used for a subset of iterations and afterwards random moves need to be considered again.

A second characteristic of Tabu Search is “diversification.” Diversification is used to escape local optimum, where for a repetitive number of iterations no amelioration is obtained to the current network configuration. In that case, diversification is used to select moves that will focus on unexplored regions in the feasibility domain.

In the hybrid meta-heuristic of FIG. 4, Tabu list, diversification and intensification strategies are incorporated in the Simulated Annealing (SA) basic algorithm described in FIG. 3, which provides a hybrid meta-heuristic with improved performance and faster convergence to a global optimal solution (i.e., a solution having a best performance metric value).

Referring again to FIG. 4, steps 202-206 may be performed the same as steps 102-106 of FIG. 3. Then, a decision is made to choose between the SA, intensification, or diversification algorithms based on information from a last n iterations (step 208). In FIG. 4, s′ refers to the state resulting from s after performing a NodeB rehome either from intensification or from Diversification or from the SA basic algorithm (see method 100 of FIG. 3). “Last n iterations information” in step 208 is a parameter that can take any integer values to decide from which of the SA basic algorithm, intensification, and diversification to choose from. Step 208 will be described in greater detail below.

The selected algorithm is then performed (step 210, 212, or 214). In one example, if the SA basic algorithm is performed (step 210), then a check is performed to determine whether the solution s′ is accepted by the SA basic algorithm (step 216), but if intensification (step 212) or diversification (step 214) are performed the solution is considered to be accepted. In the example of FIG. 4, and in the discussion below, performance of the SA basic algorithm (step 210) refers to randomly rehoming a node B (e.g., as described in step 108 of FIG. 3).

Subsequently, a check is performed to determine if the new solution s′ is already in the Tabu list (step 218). If the solution s′ is already in the Tabu list, then it is rejected (step 220). Otherwise, if the solution s′ is not yet in the Tabu list, it is accepted (step 222), and the Tabu list is updated (step 224). If the solution is the best solution yet (i.e., yielding the best performance metric according to the assigned weighting WL and WIUR) then the most recent solution s′ is defined as the global optimum solution (step 226). Steps 228-232 then proceed the same as corresponding steps 118-122 in FIG. 3.

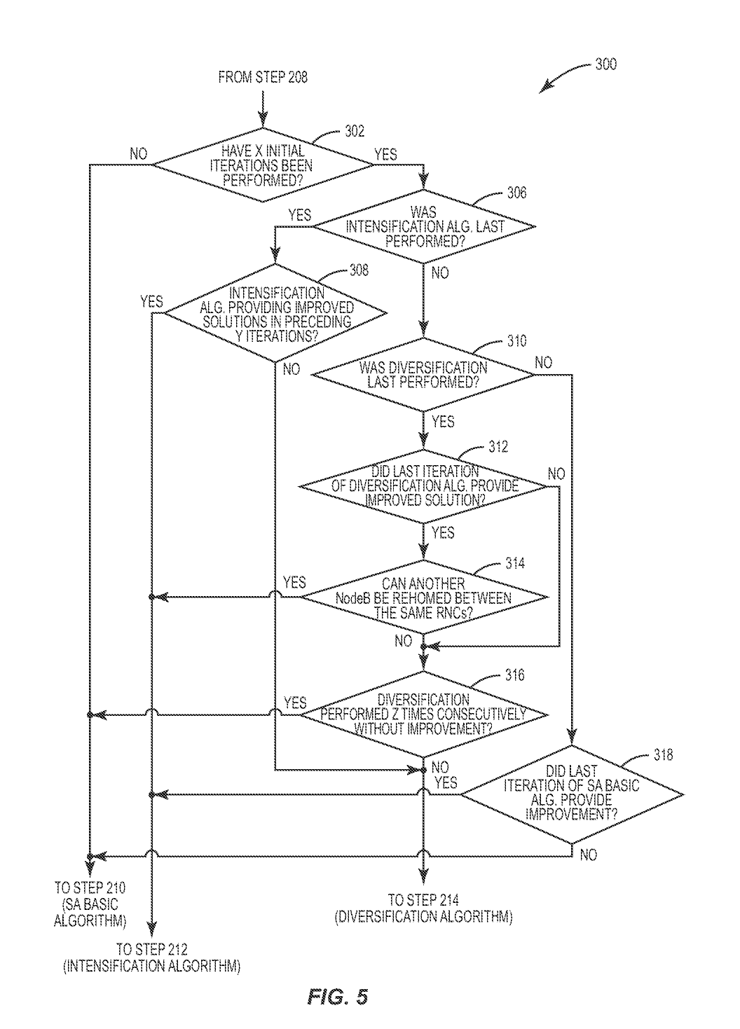

FIG. 5 illustrates an example method 300 for selecting an algorithm for use in a given iteration of the method of FIG. 4 (i.e., a method that may be performed as step 208 of FIG. 4). A check is performed to determine if X initial iterations have been performed (step 302), and if not then the SA basic algorithm is performed (i.e., step 108 is performed). This may be done to ensure that the SA basic algorithm is performed for each of X initial iterations to randomly select X rehoming configurations.

If those initial X iterations have been performed, then a check is performed to determine if intensification was last performed in a preceding iteration (step 306). If intensification was last performed, then a subsequent check is performed to determine if intensification provided performance metric improvements in a Y preceding algorithms (step 308). If improvements were achieved, then intensification is performed again. Otherwise, diversification is performed.

Referring again to step 306, if intensification was not performed in a most recent iteration, then a check is performed to see if diversification was last performed (step 310). If diversification was last performed, a check is performed to determine if the last iteration of diversification provided an improved solution (step 312), and if so, a check is performed to determine if that solution can be repeated (step 314) (i.e., can the previous move of a NodeB from a first RNC to a second RNC be repeated for another NodeB between the same two RNCs). If the solution can be repeated, then intensification is performed. Otherwise, a check is performed to determine if diversification has been performed Z times consecutively without improvement (step 316), and Z diversification iterations have not been consecutively performed without improvement, then diversification is performed again. Otherwise, if Z iterations of diversification have been performed without improvement, then the SA basic algorithm is performed.

Referring again to step 310, if diversification was not last performed, then we know that the SA basic algorithm was last performed, and a check is determined to see if the previous iteration of the SA basic algorithm provided an improvement (step 318). If no improvement was provided, the SA basic algorithm is performed again to randomly rehome a NodeB to a new RNC. Otherwise, if the previous SA basic algorithm did provide an improvement, then intensification is performed.

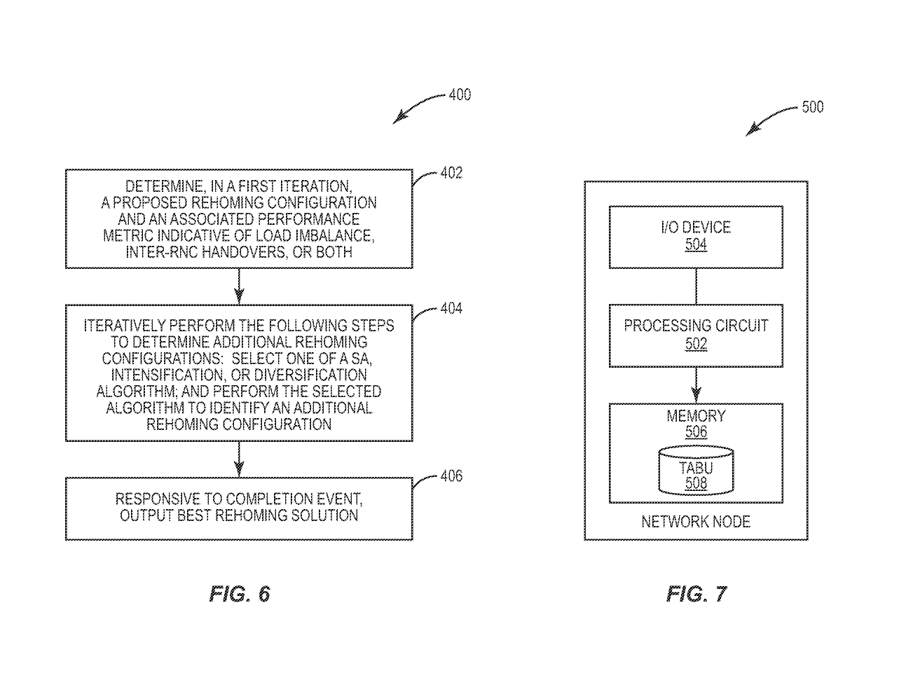

FIG. 6 illustrates a high level exemplary method 400 of determining rehoming configurations using a hybrid meta-heuristic approach. In a first iteration, a proposed rehoming configuration and an associated performance metric are determined (step 402). The performance metric is indicative of a load imbalance (e.g., MP load imbalance) of the proposed rehoming configuration, a quantity of inter-RNC handovers that would be exhibited by the proposed rehoming configuration (e.g., Iur handovers), or both.

A plurality of additional rehoming configurations are iteratively determined (step 404) by: selecting one of the SA basic algorithm, the intensification algorithm, or the diversification algorithm responsive to a type of algorithm used in the preceding iteration, the performance metric of one or more preceding iterations, or both. In each iteration, the selected algorithm is performed to identify an additional rehoming configuration.

Then, responsive to a completion event, a determined rehoming solution is outputted that has a performance metric exhibiting a greatest improvement as compared to a performance metric of an initial allocation of the plurality of base stations among the plurality of RNCs (i.e., a “global optimum” rehoming configuration) (step 406).

In one example, the completion event may correspond to the performance of a predefined quantity of iterations (e.g., 48,000 iterations as in step 228). In another example, the completion event corresponds to a predefined quantity of iterations being performed without identifying any rehoming configurations whose performance metric offers an improvement over a current optimal configuration (e.g., the SA basic algorithm being performed to randomly select a number of solutions, with none of those solutions offering an improvement to the global optimum). In yet another example, the completion event corresponds to a rehoming configuration determination time period transpiring.

The performance metric in question (e.g., the objective function C(s) discussed above) may be indicative of an extent to which an actual load balance of each RNC balance compares to an optimum load balance for each RNC.

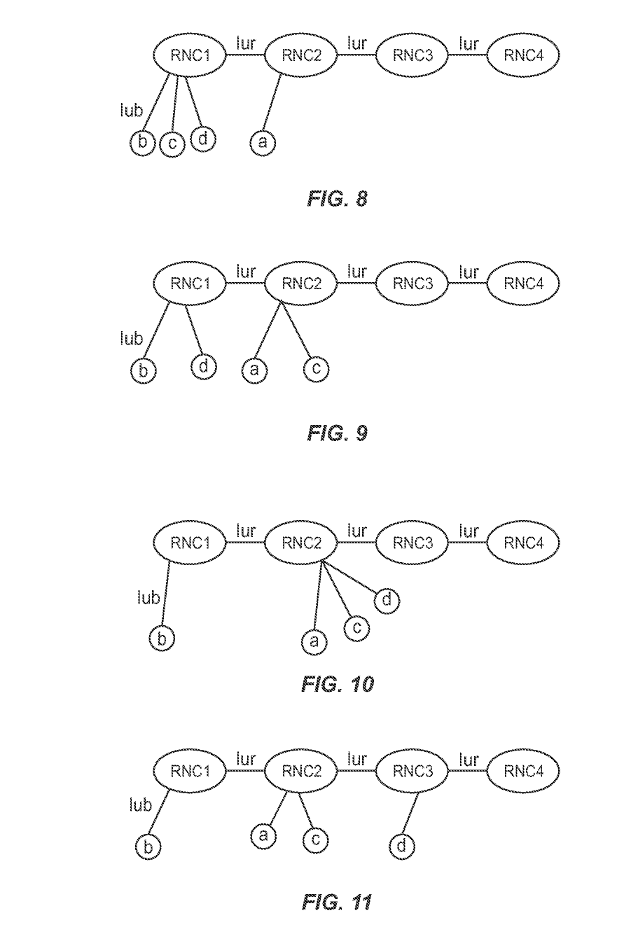

As will be demonstrated in FIGS. 8-15 below, determining an associated performance metric may include: comparing an actual total load of each the plurality of base stations to a total capacity of all of the RNCs to determine an optimum load for each RNC; determining, for each RNC, a magnitude of the difference between the optimum load for the RNC and a current load for the RNC; and defining a sum of the magnitudes to be the load imbalance. Each performance metric may be a weighted sum of the load imbalance for a proposed rehoming configuration and the estimated number of IUR interface handovers that would be exhibited by the proposed rehoming configuration.

The SA basic algorithm may be selected responsive to the diversification algorithm being performed for a predefined quantity of consecutive iterations without achieving a load imbalance reduction (see, e.g., step 316). Also, performing the SA basic algorithm may include randomly relocating a base station to a different RNC.

The intensification algorithm may be selected responsive to: the intensification algorithm providing an improvement in a preceding iteration (see, e.g., step 308), or a preceding diversification iteration that moves a base station from a source RNC to a target RNC being repeatable to move another base station from the same source RNC to the same target RNC while yielding an improved performance metric (see, e.g., step 314). Performing the intensification algorithm may include moving one of the NodeBs to a selected RNC, wherein an actual load of the selected RNC is lower than its optimal load, and wherein the move will decrease the load imbalance of the selected RNC.

The diversification algorithm may be selected responsive to: performance of the diversification algorithm in a preceding iteration identifying a rehoming configuration having a performance metric that improves upon a current optimal configuration (see, e.g., step 312); or a predefined quantity of consecutive iterations of the intensification algorithm not providing an improved solution (see, e.g., step 308). Performance of the diversification algorithm may include moving one of the base stations to a selected RNC if the move will provide a load balance imbalance reduction, even if the move will increase a load imbalance of the selected RNC.

FIG. 7 illustrates an example network node 500 operable to implement the method 400 of FIG. 6. The network node 500 includes a processing circuit 502, an input/output (I/O) device 504, and memory 506. The processing circuit 502 may include one or more microprocessors, Digital Signal Processors (DSPs), Application Specific Integrated Circuits (ASICS), and/or other programmable devices. This processing circuit may be configured to utilize instructions (e.g., stored in memory 506) to carry out one or more of the methods 200, 300, 4000. Thus, the steps of the performed method may be embodied in the network node 500 as stored computer instructions in the form of micro-code, firmware, and/or software in memory 506, for example. The memory 506 includes a Tabu list database 508 storing determined rehoming configurations. The I/O device 504 is used to communicate with external devices. In one example, the network node 500 is an RNC, and the I/O device may include a transceiver operable to communicate with other RNCs over the Iur interface.

FIGS. 8-15 will now be discussed to provide an example of how the method 200 may be used to improve the simplified network of FIG. 2. Thus, in this discussion, the configuration of FIG. 2 will be used as an initial configuration. As shown in FIG. 2, there exists four RNCS (RNC1, RNC2, RNC3 and RNC4), and four NodeBs (a, b, c, and d). Initially, each of the NodeBs belong to the same RNC1, which is their parent. For simplicity, we will assume that WIUR=0, such that only WL is considered (i.e., all priority is placed on reducing load imbalance, and no priority is placed on reducing IUR handover).

Based on a capacity calculation (e.g., an assumption), we assume that RNC1 represents 20% of the networks capacity, RNC2 30%, RNC 3 40% and RNC4 10%.

We further assume the following:

Assume that NodeB “a” has 20 MP load

Assume that NodeB “b” has 30 MP load

Assume that NodeB “c” has 20 MP load

Assume that NodeB “d” has 20 MP load

This means that the overall network MPload is the sum of all the nodes MP loads and is equal to 90. Therefore the ideal RNCs MP load for each RNC is calculated is calculated as follows:

RNC1 ideal MPload is (20*90)/100=18

RNC2 ideal MPload is (30*90)/100=27

RNC3 ideal MPload is (40*90)/100=36

RNC4 ideal MPload is (10*90)/100=9

Now let us calculate overall load imbalance in the network based on the current configuration of FIG. 2:

Load imbalance on RNC1 is |90−18|=72

Load imbalance on RNC2 is |−27|=27

Load imbalance on RNC3 is |−36|=36

Load imbalance on RNC4 is |−9|=9

Therefore the load imbalance associated with the whole network's current configuration is 72+27+36+9=144.

Now, let us consider the SA basic algorithm. Based on some random pick, NodeB “a” was chosen for re-homing from RNC1 to RNC2 (see FIG. 8). In such a case the load imbalance becomes:

Load imbalance on RNC1 is |70−18|=52

Load imbalance on RNC2 is |20−27|=7

Load imbalance on RNC3 is |−36|=36

Load imbalance on RNC4 is |−9|=9

Therefore the load imbalance associated with the whole network's current configuration is 52+7+36+9=104.

Since the load imbalance of this network configuration (104) is less than the previous one (144), the probability of accepting this network configuration is 1, this configuration is accepted.

Now, consider that NodeB “c” was randomly picked in the SA basic algorithm annealing for re-homing from RNC1 to RNC2 (see FIG. 9). In such a case the load imbalance becomes:

Load imbalance on RNC1 is |50−8|=32

Load imbalance on RNC2 is |40−27|=13

Load imbalance on RNC3 is |−36|=36

Load imbalance on RNC4 is |−9|=9

Therefore the load imbalance associated with the whole network's current configuration is 32+13+36+9=90.

This configuration is accepted since it has lower load imbalance.

Next, NodeB “d” was randomly picked using simulated annealing for re-homing from RNC1 to RNC2 (see FIG. 10).

The overall load imbalance of this potential network configuration is:

Load imbalance on RNC1 is |30−18|=12

Load imbalance on RNC2 is |b 60−27|=33

Load imbalance on RNC3 is |−36|=36

Load imbalance on RNC4 is |−9|=9

Therefore the load imbalance associated with the whole network's current configuration is 12+33+36+9=90. Notably, this is the same performance metric as the configuration of FIG. 9, but the load imbalance on RNC2 has increased from 13 to 33. The probability of acceptance of this solution is shown below, using eq. (4) from above:

$$\begin{matrix}P ( s , {s}^{′} , T ) = {e}^{\frac{- WL * ( CMP \_ load \_ imbalance ( {s}^{′ } ) - CMP \_ load \_ imbalance ( s ) )}{T \_ MP \_ load \_ imbalance}} \\ = {e}^{[ \frac{- WL * ( 90 - 90 )}{T \_ MP \_ load \_ imbalance} ]} \\ = {e}^{- 0} \\ = 1\end{matrix}$$

Thus, the probability of accepting this configuration is 1 (because RAND will not be greater than 1).

Next, NodeB “d” is randomly picked using simulated annealing for re-homing from RNC2 to RNC3 (see FIG. 11). The overall load imbalance of this potential network configuration becomes:

Load imbalance on RNC1 is |30−18|=12

Load imbalance on RNC2 is |40−27|=13

Load imbalance on RNC3 is |20−36|=16

Load imbalance on RNC4 is |−9|=9

Therefore the load imbalance associated with the whole network's current configuration is 12+13+16+9=50. This configuration is also accepted by the algorithm (as 50 is an improvement over the previous load imbalances).

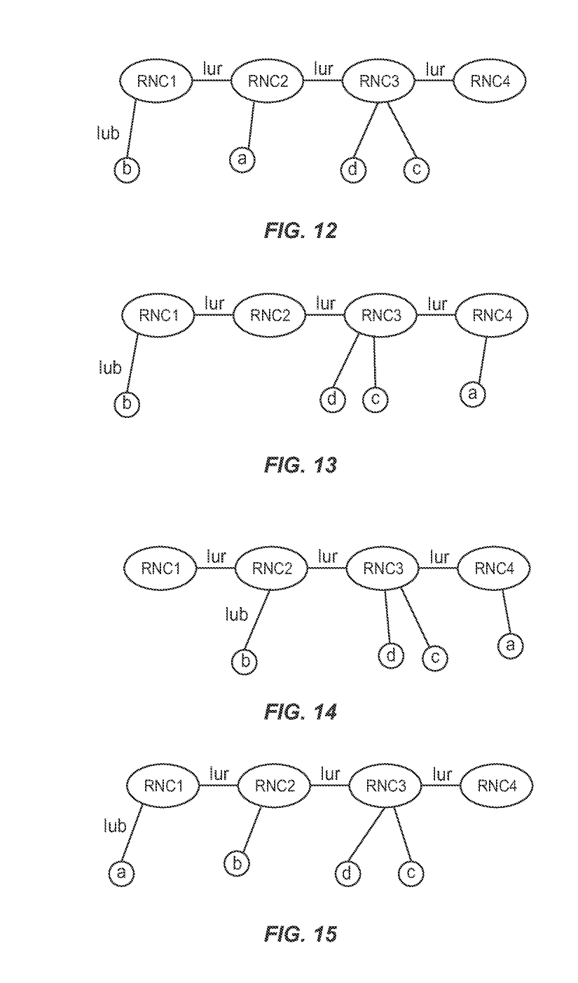

We then assume, that based on previous move, RNC3 was identified as a potential RNC to perform other rehomes since it has higher capacity (see, e.g., step 314 of FIG. 5). For this reason, intensification algorithm was adopted and therefore NodeB “c” was rehomed to RNC3 as well (see FIG. 12). Therefore the overall load imbalance becomes:

Load imbalance on RNC1 is |30−18|=12

Load imbalance on RNC2 is |20−27|=7

Load imbalance on RNC3 is |40−36|=4

Load imbalance on RNC4 is |−9|=9

Therefore the load imbalance associated with the whole network's current configuration is 12+7+4+9=32. This too is accepted as a solution.

For next move NodeB “a” was selected to be rehomed from RNC2 to RNC4 (see FIG. 13) based on diversification, since RNC4 was never been selected before, in hope to ameliorate the current solution and escape the local optima. In such a case the overall load imbalance becomes:

Load imbalance on RNC1 is |30−18|=12

Load imbalance on RNC2 is |−27|=27

Load imbalance on RNC3 is |40−36|=4

Load imbalance on RNC4 is |20−9|=11

Therefore the load imbalance associated with the whole network's current configuration is 12+27+4+11=54. As observed this solution is worse than the previous solution which was 32 (see, e.g., step 216 of FIG. 4).

Next, NodeB “b” was chosen to rehome from RNC1 to RNC2 based upon the SA basic algorithm (see FIG. 14). In such a case the overall load imbalance becomes:

Load imbalance on RNC1 is |−181=18

Load imbalance on RNC2 is |30−27|=3

Load imbalance on RNC3 is |40−36|=4

Load imbalance on RNC4 is |20−9|=11

Therefore the load imbalance associated with the whole network's current configuration is 18+3+4+11=36. This solution is accepted as it provides an improvement to previous solution.

Finally, NodeB “a” is chosen to rehome from RNC4 to RNC1 (see FIG. 15) based on the SA basic algorithm. In such a case the overall load imbalance becomes:

Load imbalance on RNC1 is |20−18|=2

Load imbalance on RNC2 is |30−27|=3

Load imbalance on RNC3 is |40−36|=4

Load imbalance on RNC4 is |−9|=9

Therefore the load imbalance associated with the whole network's current configuration is 2+3+4+9=18. This solution is accepted as it provides an improvement to previous solution.

Thus, use of the hybrid meta-heuristic approach considers an appropriate amount of the exponential number of potential rehoming configurations, to identify a global optimum configuration in a reasonable amount of time.

The hybrid meta-heuristic approach described above provides numerous advantages. First, by minimizing the MP load imbalance over a WCDMA RAN network along with reducing the Iur handover, increased network performances will result, such as better usage of network resources, reduced signaling (e.g. RNSAP signaling) over the network resulting from Iur handovers and better quality of service where less delayed connections and buffered data are present.

Better usage of the network may be achieved by MP load balancing of the RNCs where each becomes neither underused nor overused. This will extend the network lifetime before degraded performance is observed, which might lead to adding elements to the network, such as new RNCs, new RBS and/or new boards.

Utilizing the hybrid meta-heuristic approach will result in the best network configuration possible corresponding to the objective (MP load Balancing and Reduced Iur-Handover) studied. This will result in a long term solution yielding better customer satisfaction when compared to a short term solution based on common sense and pure instinct. Additionally, by better utilizing and maximizing NodeB and RNC resources, greater revenue may be earned.

Thus, the foregoing description and the accompanying drawings represent non-limiting examples of the methods and apparatus taught herein. As such, the present invention is not limited by the foregoing description and accompanying drawings. Instead, the present invention is limited only by the following claims and their legal equivalents.

What is claimed is:

1. A method of iteratively determining an optimal configuration for rehoming a plurality of base stations among a plurality of radio network controllers (RNCs) within a wireless communication network, the method comprising:
determining, in a first iteration, a proposed rehoming configuration and an associated performance metric indicative of a load imbalance of the proposed rehoming configuration, a quantity of inter-RNC handovers that would be exhibited by the proposed rehoming configuration, or both;
iteratively determining a plurality of additional rehoming configurations by:
selecting one of a simulated annealing (SA) algorithm, an intensification algorithm, or a diversification algorithm responsive to a type of algorithm used in the preceding iteration, the performance metric of one or more preceding iterations, or both; and
performing the selected algorithm to identify an additional rehoming configuration; and
outputting, responsive to a completion event, a determined rehoming solution having a performance metric exhibiting a greatest improvement as compared to a performance metric of an initial allocation of the plurality of base stations among the plurality of RNCs.

2. The method of claim 1, wherein the completion event corresponds to the performance of a predefined quantity of iterations.

3. The method of claim 1, wherein the completion event corresponds to a predefined quantity of iterations being performed without identifying any rehoming configurations whose performance metric offers an improvement over a current optimal configuration.

4. The method of claim 1, wherein the completion event corresponds to a rehoming configuration determination time period transpiring.

5. The method of claim 1, wherein the performance metric is indicative of an extent to which an actual load balance of each RNC balance compares to an optimum load balance for each RNC.

6. The method of claim 5, wherein said determining an associated performance metric comprises:
comparing an actual total load of each the plurality of base stations to a total capacity of all of the RNCs to determine an optimum load for each RNC;
determining, for each RNC, a magnitude of the difference between the optimum load for the RNC and a current load for the RNC; and
defining a sum of the magnitudes to be the load imbalance.

7. The method of claim 1, wherein each performance metric is a weighted sum of the load imbalance for a proposed rehoming configuration and the estimated number of IUR interface handovers that would be exhibited by the proposed rehoming configuration.

8. The method of claim 1, wherein each of the identified rehoming configurations and its associated performance metric is stored in a Tabu list.

9. The method of claim 1, wherein if the SA algorithm is selected, performing the selected algorithm to identify an additional rehoming configuration comprises randomly relocating a base station to a different RNC.

10. The method of claim 1, wherein if the intensification algorithm is selected, performing the selected algorithm to identify an additional rehoming configuration comprises moving one of the base stations to a selected RNC, wherein an actual load of the selected RNC is lower than its optimal load, and wherein the move will decrease the load imbalance of the selected RNC.

11. The method of claim 1, wherein if the diversification algorithm is selected, performing the selected algorithm to identify an additional rehoming configuration comprises moving one of the base stations to a selected RNC if the move will provide a load balance imbalance reduction, even if the move will increase a load imbalance of the selected RNC.

12. The method of claim 1, wherein the SA algorithm is selected responsive to the diversification algorithm being performed for a predefined quantity of consecutive iterations without achieving a load imbalance reduction.

13. The method of claim 1, wherein the intensification algorithm is selected responsive to:
the intensification algorithm providing an improvement in a preceding iteration; or
a preceding diversification iteration that moves a base station from a source RNC to a target RNC being repeatable to move another base station from the same source RNC to the same target RNC while yielding an improved performance metric.

14. The method of claim 1, wherein the diversification algorithm is selected responsive to:
performance of the diversification algorithm in a preceding iteration identifying a rehoming configuration having a performance metric that improves upon a current optimal configuration; or
a predefined quantity of consecutive iterations of the intensification algorithm not providing an improved solution.

15. A network node operative to iteratively determine an optimal configuration for rehoming a plurality of base stations among a plurality of radio network controllers (RNCs) within a wireless communication network, the network node comprising one or more processing circuits configured to:
determine, in a first iteration, a proposed rehoming configuration and an associated performance metric indicative of a load imbalance of the proposed rehoming configuration, a quantity of inter-RNC handovers that would be exhibited by the proposed rehoming configuration, or both;
iteratively perform the following to determine a plurality of additional rehoming configurations:
select one of a simulated annealing (SA) algorithm, an intensification algorithm, or a diversification algorithm responsive to a type of algorithm used in the preceding iteration, the performance metric of one or more preceding iterations, or both; and
perform the selected algorithm to identify an additional rehoming configuration; and
output, responsive to a completion event, a determined rehoming solution having a performance metric exhibiting a greatest improvement as compared to a performance metric of an initial allocation of the plurality of base stations among the plurality of RNCs.

16. The network node claim 15, wherein the completion event corresponds to the performance of a predefined quantity of iterations.

17. The network node of claim 15, wherein the completion event corresponds to a predefined quantity of iterations being performed without identifying any rehoming configurations whose performance metric offers an improvement over a current optimal configuration.

18. The network node of claim 15, wherein the completion event corresponds to a rehoming configuration determination time period transpiring.

19. The network node of claim 15, wherein the performance metric is indicative of an extent to which an actual load balance of each RNC balance compares to an optimum load balance for each RNC.

20. The network node of claim 19, wherein the one or more processing circuits configured to determine the performance metric by being configured to:
compare an actual total load of each the plurality of base stations to a total capacity of all of the RNCs to determine an optimum load for each RNC;
determine, for each RNC, a magnitude of the difference between the optimum load for the RNC and a current load for the RNC; and
define a sum of the magnitudes to be the load imbalance.

21. The network node of claim 15, wherein each performance metric is a weighted sum of the load imbalance for a proposed rehoming configuration and the estimated number of IUR interface handovers that would be exhibited by the proposed rehoming configuration.

22. The network node of claim 15, wherein each of the identified rehoming configurations and its associated performance metric is stored in a Tabu list.

23. The network node of claim 15, wherein if the SA algorithm is selected, performance of the selected algorithm to identify an additional rehoming configuration comprises randomly relocating a base station to a different RNC.

24. The network node of claim 15, wherein if the intensification algorithm is selected, performance of the selected algorithm to identify an additional rehoming configuration comprises moving one of the base stations to a selected RNC, wherein an actual load of the selected RNC is lower than its optimal load, and wherein the move will decrease the load imbalance of the selected RNC.

25. The network node of claim 15, wherein if the diversification algorithm is selected, performance of the selected algorithm to identify an additional rehoming configuration comprises moving one of the base stations to a selected RNC if the move will provide a load balance imbalance reduction, even if the move will increase a load imbalance of the selected RNC.

26. The network node of claim 15, wherein the SA algorithm is selected responsive to the diversification algorithm being performed for a predefined quantity of consecutive iterations without achieving a load imbalance reduction.

27. The network node of claim 15, wherein the intensification algorithm is selected responsive to:
the intensification algorithm providing an improvement in a preceding iteration; or
a preceding diversification iteration that moves a base station from a source RNC to a target RNC being repeatable to move another base station from the same source RNC to the same target RNC while yielding an improved performance metric.

28. The network node of claim 15, wherein the diversification algorithm is selected responsive to:
performance of the diversification algorithm in a preceding iteration identifying a rehoming configuration having a performance metric that improves upon a current optimal configuration; or
a predefined quantity of consecutive iterations of the intensification algorithm not providing an improved solution.
